(19) United States
(12) Patent Application Publication
(10) Pub. No.: US 2025/0115223 A1
(43) Pub. Date: Apr. 10, 2025

(54) VEHICULAR BRAKE-BY-WIRE SYSTEM

(71) Applicants: Hyundai Motor Company, Seoul (KR); Kia Corporation, Seoul (KR); Seohan Innobility Co., Ltd., Jincheon-gun, Chungcheongbuk-do (KR)

(72) Inventors: Hyeong Seop PARK, Hwaseong-si (KR); Chang Seop AN, Yeonsu-gu (KR); Jong Woo CHA, Hwaseong-si (KR); Jung Min CHO, Seongnam-si (KR); Jae Geun BANG, Hwaseong-si (KR); Seong Kweon JOO, Hwaseong-si (KR)

(21) Appl. No.: 18/610,054

(22) Filed: Mar. 19, 2024

(30) Foreign Application Priority Data
Oct. 5, 2023 (KR) 10-2023-0132746

(51) Int. Cl. B60T 13/66; B60T 7/04

(52) U.S. Cl. CPC B60T 13/662; B60T 7/042; B60T 2270/402; B60T 2270/404

(57) ABSTRACT

In a vehicular brake-by-wire system, when a motor needs to generate brake hydraulic pressure, but fails to drive due to a trouble with the motor, a failure in the controller, or the like, a driver operates a pneumatic cylinder by operating pneumatic valve switch, and a master cylinder operates by the operation of the pneumatic cylinder, thereby possibly generating brake hydraulic pressure for vehicular braking.

### CROSS REFERENCE TO RELATED APPLICATION

The present application claims priority of Korean Patent Application No. 10-2023-0132746, filed on Oct. 5, 2023, the entire contents of which are incorporated herein for all purposes by this reference.

### TECHNICAL FIELD

The present disclosure relates to a vehicular brake-by-wire system and, more particularly, to a technology associated with a vehicular brake-by-wire system capable of performing emergency braking using pneumatic pressure when a situation where braking is not possible occurs due to a trouble with a motor or communication interruption.

### BACKGROUND

Existing vehicular brake systems use a mechanical hydraulic system. However, the mechanical hydraulic system has disadvantages in that a configuration is complex and maintenance is difficult. In recent years, brake-by-wire systems (electronic brake systems) that generate hydraulic pressure for braking using an electric signal have been developed and used.

These brake-by-wire systems generate the hydraulic pressure for braking using a motor according to a driver's intention to apply braking, and generate a brake force by transferring brake hydraulic pressure generated by driving a motor to a wheel brake (wheel cylinder) of each vehicular wheel.

The brake-by-wire system that, in this manner, controls the occurrence of the brake hydraulic pressure by driving the motor is commonly referred to as an electro-hydraulic brake (EHB) system, that is, an electronic hydraulic brake system.

However, a disadvantage with brake-by-wire systems in the related art is that they may not generate a brake force, thereby not ensuring passenger safety, in a case where a trouble with the motor occurs or communication interruption occurs due to a problem with an electronic device.

The foregoing is intended merely to aid in the understanding of the background of the present disclosure, and is not intended to mean that the present disclosure falls within the purview of the related art that is already known to those skilled in the art.

### SUMMARY

An object of the present disclosure is to provide a vehicular brake-by-wire system equipped with an emergency brake function, the vehicular brake-by-wire system being capable of generating a brake force using pneumatic pressure as an alternative method in a case where a trouble with a motor occurs or communication interruption occurs due to a problem with an electronic device, and thus of applying a brake force according to a driver's intention without failing in a vehicular brake function. As a result, the vehicular brake-by-wire system can prevent the occurrence of an accident caused by a defective brake and further enhance passenger safety.

According to an aspect of the present disclosure described in this application, a vehicular brake-by-wire system includes: a brake pedal configured to generate a brake signal; a pneumatic valve switch operated to use pneumatic pressure stored in a pneumatic tank; a brake force generation module configured to generate brake hydraulic pressure by receiving a brake signal of the brake pedal or to generate the brake hydraulic pressure using the pneumatic pressure when operating the pneumatic valve switch; a controller configured to control operation of the brake force generation module using the signal of the brake pedal; and front- and rear-wheel brakes configured to operate in such a manner to generate a brake force by receiving the brake hydraulic pressure of the brake force generation module.

In the vehicular brake-by-wire system, the brake force generation module may include a first module configured to generate the brake hydraulic pressure for the front-wheel brake; and a second module configured to generate the brake hydraulic pressure for the rear-wheel brake, and the first module and the second module may have the same configuration.

In the vehicular brake-by-wire system, the controller may control operation of the first module and operation of the second module simultaneously or individually.

In the vehicular brake-by-wire system, when operating the pneumatic valve switch, the first module and the second module may operate simultaneously or independently of each other.

In the vehicular brake-by-wire system, the controller may include: a first control unit configured to receive a stroke signal of the brake pedal; and second and third control units configured to control the operation of the first module and the operation of the second module, respectively, by receiving a signal of the first control unit.

In the vehicular brake-by-wire system, each of the first module and the second module may include: a motor configured to operate under the control of a controller when operating the brake pedal; a decelerator configured to move in a straight line by receiving a rotational movement of the motor and thus to generate a thrust force; a first master cylinder configured to generate hydraulic pressure by the straight-line movement of the decelerator; a second master cylinder configured to transfer or generate the brake hydraulic pressure by receiving the hydraulic pressure of the first master cylinder; and a manifold configured to distribute the brake hydraulic pressure of the second master cylinder to front-wheel left-side and right-side brakes and rear-wheel left-side and right-side brakes.

In the vehicular brake-by-wire system, each of the first module and the second module may further include: a pneumatic cylinder configured to operate by receiving the pneumatic pressure when operating the pneumatic valve switch, and the pneumatic cylinder may be connected to the second master cylinder and may generate the brake hydraulic pressure by receiving an operation force of the pneumatic cylinder.

In the vehicular brake-by-wire system, the decelerator and the pneumatic cylinder may have the same operational direction.

In the vehicular brake-by-wire system, the pneumatic tank, the pneumatic valve switch, and the pneumatic cylinder may be connected to each other through a pneumatic pressure line, and a solenoid valve that operates to transfer the pneumatic pressure to the pneumatic cylinder of the first module and the pneumatic cylinder of the second module may be provided on a path of the pneumatic pressure line.

In the vehicular brake-by-wire system, the solenoid valve may be configured as a two-port two-position valve in a case where the first module and the second module operate independently of each other when operating the pneumatic valve switch.

In the vehicular brake-by-wire system, only one of the motor and the pneumatic cylinder may operate solely, or both the motor and the pneumatic cylinder may operate simultaneously.

The vehicular brake-by-wire system may further include a compressor configured to generate air pressure by compressing air when operating, the compressor being connected to the pneumatic tank.

In the vehicular brake-by-wire system, the controller may further include: a front control unit configured to transfer a signal between the first control unit and the second control unit; and a rear control unit configured to transfer a signal between the first control unit and the third control unit.

According to another aspect of the present disclosure, there is provided a vehicular brake-by-wire system including: a motor configured to operate under the control of a controller during a driver's operation of a brake pedal; a master cylinder configured to operate by receiving a motive power of the motor and thus to generate hydraulic pressure for braking; and a pneumatic cylinder configured to operate using pneumatic pressure during a driver's operation of a pneumatic valve switch and to operate the master cylinder when operating the pneumatic cylinder, wherein when a trouble with the motor, a failure in the controller, or communication interruption occurs, a driver operates the pneumatic cylinder by operating the pneumatic valve switch, the master cylinder operates by the operation of the pneumatic cylinder, thereby generating the hydraulic pressure for braking, and generated brake hydraulic pressure is transferred to a front wheel brake and a rear wheel brake, resulting in generating a vehicular brake force according to the driver's intention.

In a case where the brake hydraulic pressure may not be generated when the motor does not operate due to the trouble with the motor, the failure in the controller, the communication interruption, or the like, the pneumatic valve switch is manually operated. At this time, the pneumatic cylinder operates, and thus the master cylinder is operated, thereby generating the brake hydraulic pressure. The brake hydraulic pressure generated in this manner is transferred to the front wheel brake and the rear wheel brake, and thus the vehicular brake force is generated according to the driver's intention. Accordingly, the advantage of preventing the occurrence of the accident caused by the defective brake and further enhancing the passenger safety can be achieved.

### BRIEF DESCRIPTION OF THE DRAWINGS

The above and other objects, features and other advantages of the present disclosure will be more clearly understood from the following detailed description when taken in conjunction with the accompanying drawings.

FIG. 1 is a schematic view illustrating an example of a vehicular brake-by-wire system.

FIG. 2 is a view showing an example of a first module and a second module of a brake force generation module.

FIG. 3 is a top view illustrating the first module and the second module in FIG. 2.

FIG. 4 is a view illustrating the first module and the second module, when viewed from the rear.

FIG. 5 is a side view illustrating the first module and the second module, both in the upright position, in FIG. 2 that are oriented to face toward the leftward direction.

FIGS. 6 to 8 are views showing an example of an operational mechanism of the vehicular brake-by-wire system.

### DETAILED DESCRIPTION

One or more implementations of the present disclosure will be described in detail below with reference to the accompanying drawings. The same or similar constituent elements are given the same reference numeral, and descriptions thereof are not repeated.

The term “unit” or “control unit” included in the name of a constituent element, such as a motor control unit (MCU) or a hybrid control unit (HCU), is a widely used term for the name of a controller that controls a vehicular specific function and does not refer to a generic function unit.

In some implementations, a controller may include a communication device that communicates with another controller or a sensor in order to control a function for which the controller is responsible, a memory in which an operating system or logic command, input and output information, and the like are stored, and one or more processors that perform judgments, computations, determinations, and the like that are configured to control the function for which the controller is responsible.

One or more examples of a vehicular brake-by-wire system will be described below with reference to the accompanying drawings.

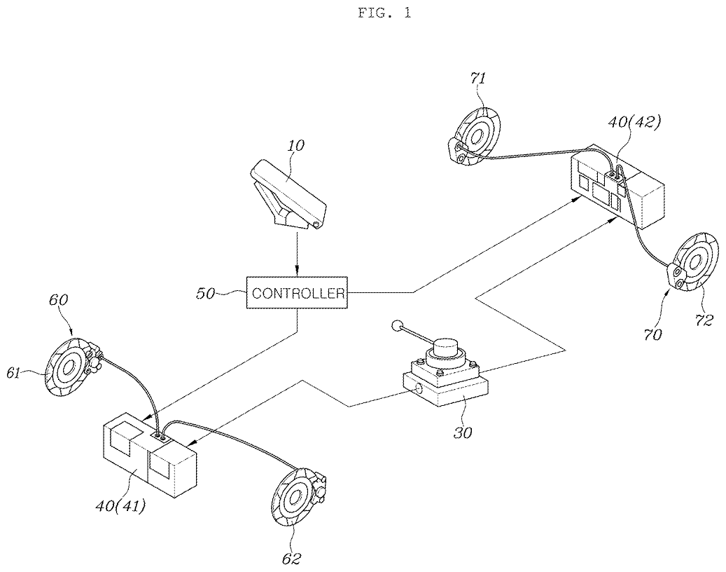

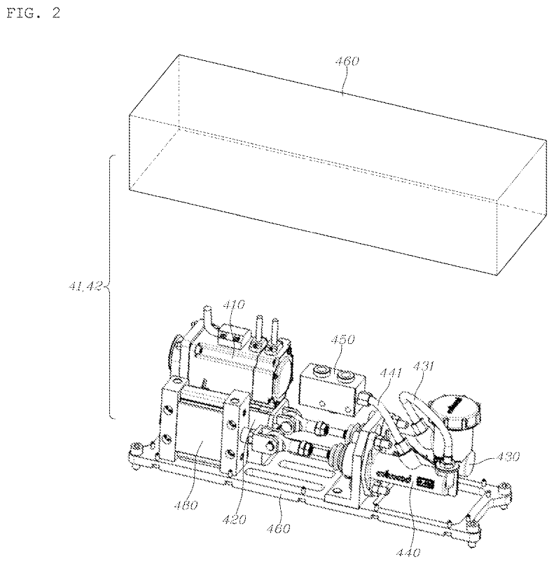

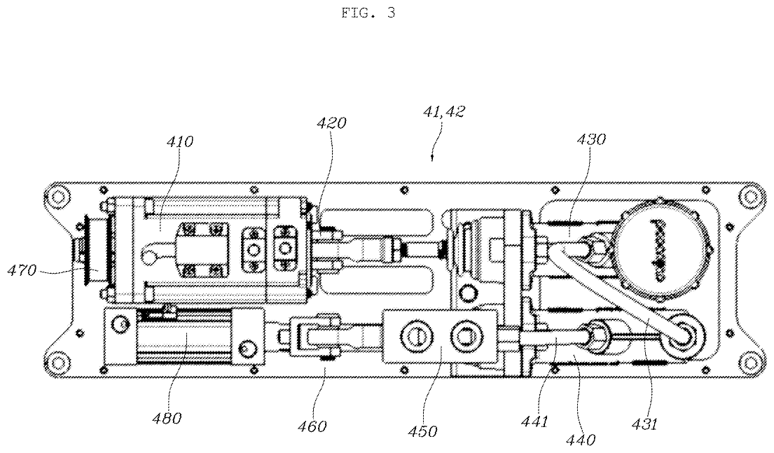

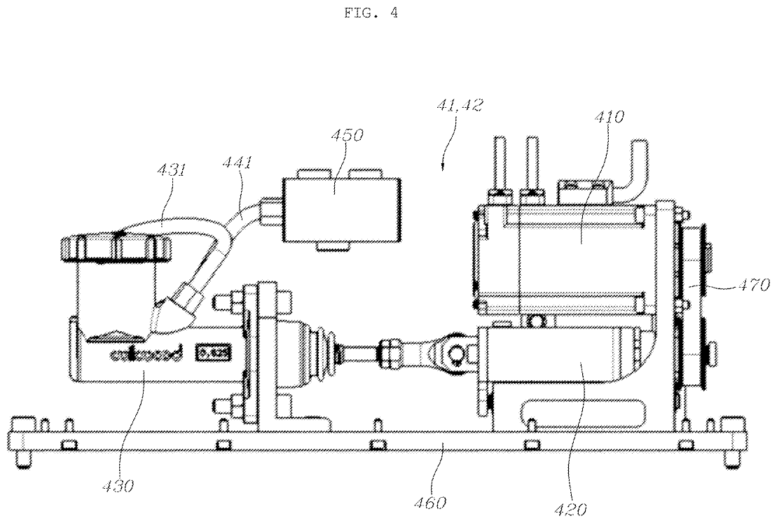

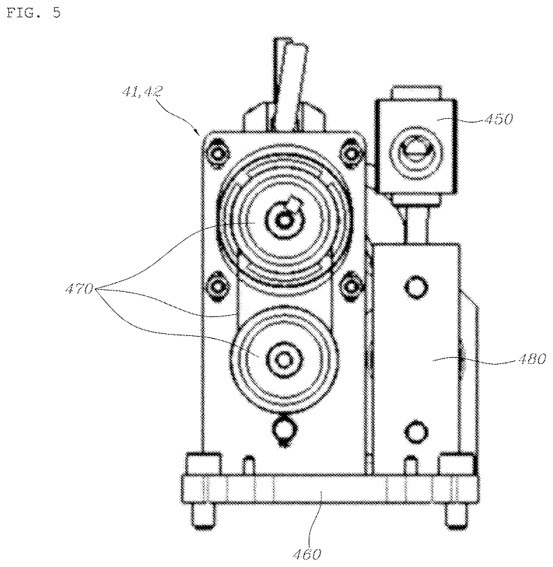

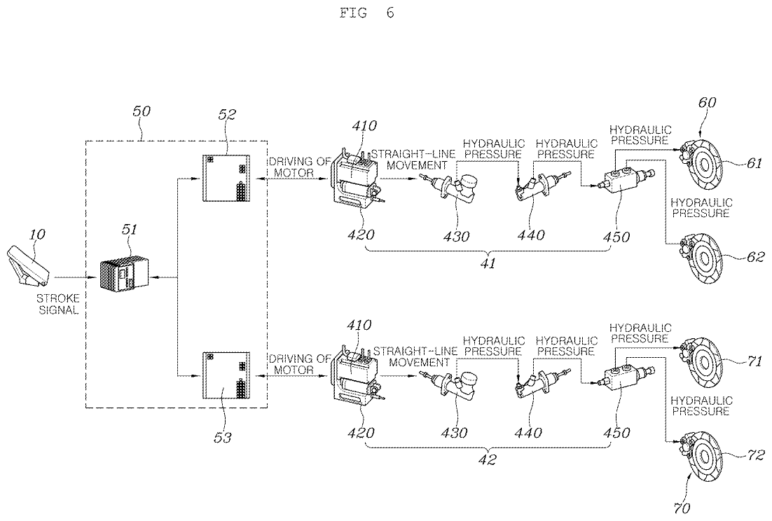

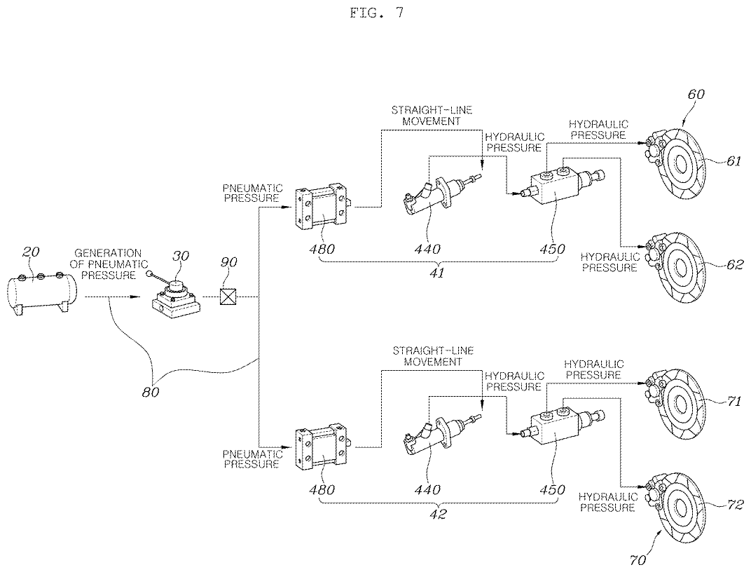

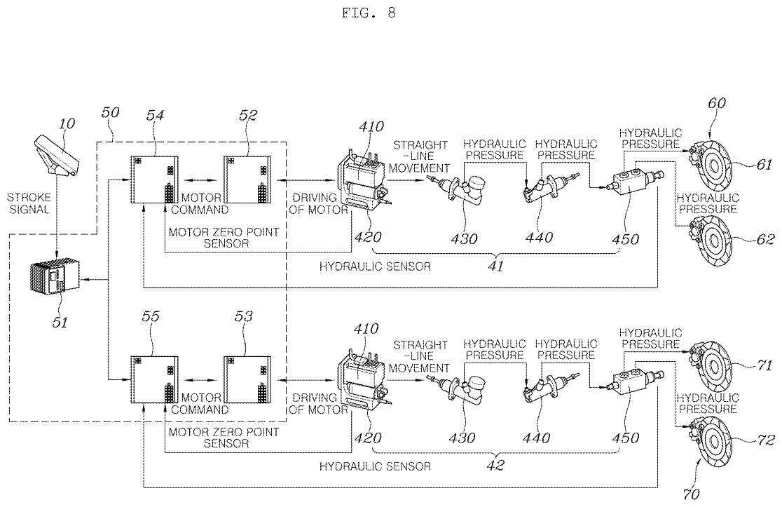

For example, the vehicular brake-by-wire system, as illustrated in FIGS. 1 to 8, includes a brake pedal 10, a pneumatic valve switch 30, a brake force generation module 40, a controller 50, and front- and rear-wheel brakes 60 and 70. The brake pedal 10 generates a brake signal during a driver's operation of the brake pedal 10. The pneumatic valve switch 30 is operated to use pneumatic pressure stored in a pneumatic tank 20. The brake force generation module 40 receives the brake signal of the brake pedal 10 and thus generates brake hydraulic pressure, or when the pneumatic valve switch 30 operates, generates the brake hydraulic pressure using the pneumatic pressure. The controller 50 controls operation of the brake force generation module 40 using the brake signal of the brake pedal 10. The front- and rear-wheel brakes 60 and 70 receive the brake hydraulic pressure of the brake force generation module 40 and thus operate to generate respective brake forces.

The brake pedal 10 and the pneumatic valve switch 30 are installed in such a manner as to be positioned at a driver's vehicular seat. The brake pedal 10 is operated with a driver's foot. When the brake pedal 10 is operated, the brake signal is generated. The pneumatic valve switch 30 is operated with the driver's hand. When the pneumatic valve switch 30 is operated, the pneumatic pressure stored in the pneumatic tank 20 can be transferred to a pneumatic cylinder described below.

Because the pneumatic tank 20 includes a compressor 100, the pneumatic tank 20 can compress air to a certain pressure level. Accordingly, the compressed air can be stored in the pneumatic tank 20 and kept there. When the pneumatic valve switch 30 is open with a driver's operation, the compressed air in the pneumatic tank 20 can be transferred to the pneumatic cylinder.

The compressor 100 is connected to the pneumatic tank 20. When operating, the compressor 100 generates air pressure by compressing air. The pneumatic pressure generated by the operation of the compressor 100 is stored in the pneumatic tank 20 and kept there.

The brake force generation module 40 is a device that generates the brake hydraulic pressure for braking by the front wheel brake 60 and the rear wheel brake 70. The brake force generation module 40 can operate under the control of the controller 50 that responds to the operation of the brake pedal 10 or can operate using the pneumatic pressure that is generated by an operation of opening the pneumatic valve switch 30.

The brake force generation module 40 includes a first module 41 and a second module 42. The first module 41 generates the brake hydraulic pressure for braking by the front wheel brake 60. The second module 42 generates the brake hydraulic pressure for braking by the rear wheel brake 70. The first module 41 and the second module 42 have the same configuration.

The brake hydraulic pressure generated in the first module 41 is supplied to a front-wheel left-side brake 61 and a front-wheel right-side brake 62. The brake hydraulic pressure generated in the second module 42 is supplied to a rear-wheel left-side brake 71 and a rear-wheel right-side brake 72.

That is, the front wheel brake 60 includes the front-wheel left-side brake 61 and the front-wheel right-side brake 62 that receive the brake hydraulic pressure generated in the first module 41 of the brake force generation module 40.

Likewise, the rear wheel brake 70 includes the rear-wheel left-side brake 71 and the rear-wheel right-side brake 72 that receive the brake hydraulic pressure generated in the second module 42 of the brake force generation module 40.

The controller 50 can operate the respective operations of the first module 41 and the second module 42 second or individually. When the pneumatic valve switch 30 operates, the first module 41 and the second module 42 can operate simultaneously or independently of each other.

In a case where the first module 41 and the second module 42 operate simultaneously under the control of the controller 50 or by the operation of the pneumatic valve switch 30, the brake force can be generated to front wheels and rear wheels, thereby providing strong braking. In a case where the first module 41 and the second module 42 operate independently of each other, a function such as electronic stability control (ESC) or anti-lock brake system (ABS) operation can be readily performed.

The controller 50 may include a first control unit 51, a second control unit 52, and a third control unit 53. The first control unit 51 receives a stroke signal of the brake pedal 10. The second control unit 52 and the third control unit 53 receive a signal of the first control unit 51 and control the first module 41 and the second module 42, respectively.

One controller 50 may be configured to be separated into the first control unit 51, the second control unit 52, and the third control unit 53. Alternatively, one controller 50 may be configured with 3 controllers that are individually independent of each other.

Each of the first module 41 and the second module 42 that have the same configuration includes a motor 410, a decelerator 420, a first master cylinder 430, a second master cylinder 440, and a manifold 450. The motor 410 operates under the control of the controller 50 when operating the brake pedal 10. The decelerator 420 moves in a straight line by receiving a rotational movement of the motor 410 and thus generates a thrust force. The first master cylinder 430 generates hydraulic pressure by the straight-line movement of the decelerator 420. The second master cylinder 440 receives the hydraulic pressure of the first master cylinder 430 and transfers or generates brake hydraulic pressure. The manifold 450 distributes the brake hydraulic pressure of the second master cylinder 440 to the front-wheel left-side brake 61 and the front-wheel right-side brake 62, and the rear-wheel left-side brake 71 and the rear-wheel right-side brake 72.

Each of the first module 41 and the second module 42 may include a housing 460 that forms the exterior appearance thereof and protects components inside. The housing 460 may include a base portion that forms the bottom thereof and a cover portion that is separably coupled to the base portion.

Components, including the motor 410, the decelerator 420, the first master cylinder 430, the second master cylinder 440, and the manifold 450, are installed in such a manner as to be positioned on the base portion of the housing 460. The cover portion covers and thus protects the components.

A motive power of the motor 410 is transferred to the decelerator 420 through a belt pulley 470. The rotational movement of the motor 410 is converted into a straight movement in the decelerator 420.

As the decelerator 420, a ball nut decelerator may be used that produces less noise and operates reliably.

The first master cylinder 430 generates hydraulic pressure by the straight-line movement of the decelerator 420. The second master cylinder 440 operates by the hydraulic pressure generated in the first master cylinder 430 and thus generates brake hydraulic pressure for braking.

The first master cylinder 430 and the second master cylinder 440 are connected to a hydraulic hose 431, and thus hydraulic pressure is transferrable from the first master cylinder 430 to the second master cylinder 440.

In some examples, the first master cylinder 430 and the second master cylinder 440 may also be configured as one master cylinder.

The brake hydraulic pressure generated in the second master cylinder 440 is transferred to the manifold 450 through the hydraulic hose 441. The brake hydraulic pressure is supplied to each of the front wheel brake 60 and the rear wheel brake 70 through the manifold 450.

That is, the brake hydraulic pressure flows into two separate lines in the manifold 450 of the first module 41. The brake hydraulic pressure is supplied to the front-wheel left-side brake 61 along one separate line, and the brake hydraulic pressure is supplied to the front-wheel right-side brake 62 along the other separate line.

Likewise, the brake hydraulic pressure flows into two separate lines the manifold 450 of the second module 42. The brake hydraulic pressure is supplied to the rear-wheel left-side brake 71 along one separate line, and the brake hydraulic pressure is supplied to the rear-wheel right-side brake 72 along the other separate line.

In some examples, each of the first module 41 and the second module 42 may further include a pneumatic cylinder 480 that operates by receiving pneumatic pressure when operating the pneumatic valve switch 30.

The pneumatic cylinder 480 moves in a straight line by receiving the pneumatic pressure. The pneumatic cylinder 480 is connected to the second master cylinder 440. The second master cylinder 440 operates by receiving the straight-line movement of the pneumatic cylinder 480, and thus generates brake hydraulic pressure for braking. The brake hydraulic pressure generated in the second master cylinder 440, as described above, is transferred to the manifold 450 through the hydraulic hose 441. The brake hydraulic pressure is supplied to each of the front wheel brake 60 and the rear wheel brake 70 through the manifold 450.

In some implementations, the motor 410 does not operate when a trouble with the motor 410, a failure in the controller 50, or communication interruption occurs. Thus, the brake hydraulic pressure is prevented from being generated in the second master cylinder 440.

At this point, a driver operates the pneumatic cylinder 480 by operating the pneumatic valve switch 30 and using the pneumatic pressure of the pneumatic tank 20. Then, the driver generates the hydraulic pressure for braking by operating the second master cylinder 440 by the operation of the pneumatic cylinder 480. The brake hydraulic pressure generated in this manner is finally transferred to the front wheel brake 60 and the rear wheel brake 70. Consequently, the vehicular brake force is generated according to the driver's intention. Accordingly, the advantage of preventing the occurrence of an accident caused by a defective brake and further enhancing passenger safety can be achieved.

In some implementations, the decelerator 420 and the pneumatic cylinder 480 that constitute each of the first module 41 and the second module 42 feature the same operational direction.

That is, the decelerator 420 and the pneumatic cylinder 480 are installed in such a manner as to be parallel with each other and move in the straight line. The decelerator 420 and the pneumatic cylinder 480 have the same operational direction due to the straight-line movement. Accordingly, the advantage of configuring the brake force generation module 40 to be compact in external size can be achieved.

In some implementations, the pneumatic tank 20, the pneumatic valve switch 30, and the pneumatic cylinder 480 are connected to each other through a pneumatic pressure line 80. The pneumatic pressure line 80 may be a hose. A solenoid valve 90 may be provided on a path of the pneumatic pressure line 80. The solenoid valve 90 operates to transfer the pneumatic pressure to the pneumatic cylinder 480 of the first module 41 and the pneumatic cylinder 480 of the second module 42.

The operation of the pneumatic cylinder 480 can be controlled more precisely than in a case where the pneumatic cylinder 480 is used together with the solenoid valve 90. Accordingly, the advantage of being able to apply precise braking can be achieved.

In some implementations, in a case where the first module 41 and the second module 42 operate independently of each other when operating the pneumatic valve switch 30, the solenoid valve 90 may be configured as a two-port two-position valve. The pneumatic pressure is supplied to the pneumatic cylinder 480 of the first module 41 through the two-port two-position valve, and thus, when controlling the front wheel brake 60, the pneumatic pressure can be prevented from being supplied to the pneumatic cylinder 480 of the second module 42. Furthermore, the pneumatic pressure is supplied to the pneumatic cylinder 480 of the second module 42 through the two-port two-position valve, and thus, when controlling the rear wheel brake 70, the pneumatic pressure can be prevented from being supplied to the pneumatic cylinder 480 of the first module 41. As a result, the first module 41 and the second module 42 can be operated independently of each other.

In some implementations, only one of the motor 410 and the pneumatic cylinder 480 can operate solely. Alternatively, both the motor 410 and the pneumatic cylinder 480 can operate simultaneously. In a case where both the motor 410 and the pneumatic cylinder 480 operate simultaneously, a fail-safe function may also be performed.

In some implementations, the controller 50 may further include a front control unit 54 and a rear control unit 55. The front control unit 54 transfers a signal between the first control unit 51 and the second control unit 52. The rear control unit 55 transfers a signal between the first control unit 51 and the third control unit 53.

The front control unit 54 and the rear control unit 55 can perform communication to a motor zero point sensor, communication to a brake pressure sensor, motor brake control, relay control, and transmission of a feedback command resulting from checking brake pressure.

The first control unit 51 and the second control unit 52 can generate a signal associated with driving of the motor 410.

In some implementations, a vehicular brake-by-wire system includes: a motor 410 operating under the control of a controller 50 during a driver's operation of a brake pedal 10; a master cylinder operating by receiving a motive power of the motor 410 and thus generating hydraulic pressure for braking; and a pneumatic cylinder 480 operating using pneumatic pressure during a driver's operation of a pneumatic valve switch 30 and operating the master cylinder when operating the pneumatic cylinder 480, wherein when a trouble with the motor 410, a failure in the controller 50, or communication interruption occurs, a driver operates the pneumatic cylinder 480 by operating the pneumatic valve switch 30, the master cylinder operates by the operation of the pneumatic cylinder 480, thereby generating the hydraulic pressure for braking, and generated brake hydraulic pressure is transferred to a front wheel brake 60 and a rear wheel brake 70, resulting in generating a vehicular brake force according to the driver's intention.

As described above, in a case where the brake hydraulic pressure may not be generated when the motor 410 does not operate due to the trouble with the motor 410, the failure in the controller 50, the communication interruption, or the like, the pneumatic valve switch 30 is manually operated. At this time, the pneumatic cylinder 480 operates using the pneumatic pressure, and thus the master cylinder is operated, thereby generating the brake hydraulic pressure. The brake hydraulic pressure generated in this manner is transferred to the front wheel brake 60 and the rear wheel brake 70, and thus the vehicular brake force is generated according to the driver's intention. Accordingly, the advantage of preventing the occurrence of the accident caused by the defective brake and further enhancing the passenger safety can be achieved.

The specific implementations of the present disclosure are described with reference to the drawings, but it would be obvious to a person of ordinary skill in the art that various modifications and alterations may possibly be made to the present disclosure without departing from the technical idea of the present disclosure that is defined in the following claims.

What is claimed is:

1. A vehicular brake-by-wire system comprising:
a brake pedal configured to generate a brake signal;
a pneumatic valve switch configured to operate based on pneumatic pressure in a pneumatic tank;
a brake force generation module configured (i) to generate brake hydraulic pressure based on receiving the brake signal of the brake pedal or (ii) to generate the brake hydraulic pressure using the pneumatic pressure based on an operation of the pneumatic valve switch;
a controller configured to control operation of the brake force generation module based on the brake signal of the brake pedal;
a front-wheel brake configured to operate to generate a front brake force based on receiving the brake hydraulic pressure of the brake force generation module; and
a rear-wheel brake configured to operate to generate a rear brake force based on receiving the brake hydraulic pressure of the brake force generation module.

2. The vehicular brake-by-wire system of claim 1, wherein the brake force generation module comprises:
a first module configured to generate the brake hydraulic pressure for the front-wheel brake; and
a second module configured to generate the brake hydraulic pressure for the rear-wheel brake, and
wherein the first module and the second module have a same configuration.

3. The vehicular brake-by-wire system of claim 2, wherein the controller is configured to control operation of the first module and operation of the second module simultaneously or individually.

4. The vehicular brake-by-wire system of claim 2, wherein the first module and the second module operate are configured to operate simultaneously or independently of each other based on the pneumatic valve switch being operated.

5. The vehicular brake-by-wire system of claim 2, wherein the controller comprises:
a first control unit configured to receive a stroke signal of the brake pedal; and
second and third control units configured to control operation of the first module and operation of the second module, respectively, based on receiving a signal of the first control unit.

6. The vehicular brake-by-wire system of claim 2, wherein the front-wheel brake comprises a front-wheel left-side brake and a front-wheel right-side brake,
wherein the rear-wheel brake comprises a rear-wheel left-side brake and a rear-wheel right-side brake,
wherein each of the first module and the second module comprises:
a motor configured to operate by control of the controller based on the brake pedal being operated;
a decelerator configured to move linearly based on receiving a rotational movement of the motor to thereby generate a thrust force;
a first master cylinder configured to generate hydraulic pressure based on a linear movement of the decelerator;
a second master cylinder configured to transfer or generate the brake hydraulic pressure based on receiving the hydraulic pressure of the first master cylinder; and
a manifold configured to distribute the brake hydraulic pressure of the second master cylinder to the front-wheel left-side brake, the front-wheel right-side brake, the rear-wheel left-side brake, and the rear-wheel right-side brake.

7. The vehicular brake-by-wire system of claim 6, wherein each of the first module and the second module further comprises:
a pneumatic cylinder configured to operate by receiving the pneumatic pressure based on the pneumatic valve switch being operated, and
wherein the pneumatic cylinder is connected to the second master cylinder and configured to generate the brake hydraulic pressure based on receiving an operation force of the pneumatic cylinder.

8. The vehicular brake-by-wire system of claim 7, wherein the decelerator and the pneumatic cylinder have a same operational direction.

9. The vehicular brake-by-wire system of claim 7, further comprising:
a pneumatic pressure line that connects the pneumatic tank, the pneumatic valve switch, and the pneumatic cylinder are connected to one another; and
a solenoid valve disposed at the pneumatic pressure line and configured to operate to transfer the pneumatic pressure to the pneumatic cylinder of the first module and the pneumatic cylinder of the second module.

10. The vehicular brake-by-wire system of claim 9, wherein the solenoid valve comprises a two-port, two-position valve, and
wherein the first module and the second module are configured operate independently of each other based on the pneumatic valve switch being operated.

11. The vehicular brake-by-wire system of claim 7, wherein one of the motor or the pneumatic cylinder is configured to operate while the other one of the motor or the pneumatic cylinder stops operating, or
wherein both of the motor and the pneumatic cylinder are configured to operate simultaneously.

12. The vehicular brake-by-wire system of claim 1, further comprising:
a compressor connected to the pneumatic tank and configured to generate air pressure by compressing air.

13. The vehicular brake-by-wire system of claim 5, wherein the controller further comprises:
a front control unit configured to transfer a signal between the first control unit and the second control unit; and
a rear control unit configured to transfer a signal between the first control unit and the third control unit.

14. A vehicular brake-by-wire system comprising:
a motor configured to operate based on control of a controller in response to an operation of a brake pedal by a user;
a master cylinder configured to operate based on receiving a motive power of the motor to thereby generate hydraulic pressure;
a pneumatic valve switch configured to be operated by the user; and
a pneumatic cylinder configured to operate based on pneumatic pressure based on an operation of the pneumatic valve switch by the user,
wherein the master cylinder is configured to operate based on the pneumatic cylinder being operated, and
wherein the pneumatic valve switch is configured to, in a state in which a trouble with the motor, a failure in the controller, or a communication interruption occurs, be operated by the user to thereby operate the pneumatic cylinder and the master cylinder and provide the hydraulic pressure generated by the master cylinder to a front wheel brake and a rear wheel brake.
